(19) United States
(12) Patent Application Publication
(10) Pub. No.: US 2023/0252112 A1
(43) Pub. Date: Aug. 10, 2023

(54) INSTANCE-BASED LICENSES OF COMPUTER PROGRAMS AND APPROACHES TO IMPLEMENTING THE SAME IN A DIGITAL DISTRIBUTION PLATFORM

(71) Applicant: Tafonic LLC, East Palo Alto, CA (US)

(72) Inventor: Anil RAO, Santa Clara, CA (US)

(21) Appl. No.: 18/163,163

(22) Filed: Feb. 1, 2023

Related U.S. Application Data
(60) Provisional application No. 63/307,471, filed on Feb. 7, 2022.

(51) Int. Cl. G06F 21/10

(52) U.S. Cl. CPC G06F 21/105; G06F 2221/0771

(57) ABSTRACT

Introduced here is a digital distribution platform that associates licenses with instances of applications rather than users or computing devices. The digital distribution platform may facilitate distribution of applications that reside on a cloud computing infrastructure. While these “cloud-native” applications may be implemented on the cloud computing infrastructure, the digital distribution platform can provide a convenient source through which to access these cloud-native applications.

### CROSS-REFERENCE TO RELATED APPLICATIONS

This application claims priority to U.S. Provisional Application No. 63/307,471, titled “Instance-Based Licenses of Computer Programs and Approaches to Implementing the Same in a Digital Distribution Platform” and filed on Feb. 7, 2022, which is incorporated herein by reference in its entirety.

### TECHNICAL FIELD

Various embodiments concern computer programs and associated computer-implemented techniques for associating licenses with instances of applications in a dynamic manner.

### BACKGROUND

A software license (or simply “license”) is a legal instrument governing the use of redistribution of software, generally in the form of a computer program (also called an “application”). A license grants the licensee permission to use one or more copies of the application in ways where such use would otherwise potentially constitute infringement of the developer's exclusive rights under copyright.

Licenses have historically been distributed using two different schemes.

With the first scheme, licenses are used to limit the number of computing devices on which an application can be installed. These licenses are commonly referred to as “device-based licenses.” A device-based license is associated with the computing device on which the application is installed. Assume, for example, that the developer provides a code that needs to be entered when the application is initially installed on, or accessed by, a computing device. In such a scenario, an identifier that is representative of the computing device may be programmatically associated with the license permitting use of the application. Examples of device identifiers include serial numbers, media access control (“MAC”) addresses, internet protocol (“IP”) addresses, and the like. In the event that the license permits use of the application by multiple computing devices, more than one device identifier may be programmatically associated with the license (e.g., through storage in a data structure maintained by the developed). This may occur if a company licenses an application for some or all of its employees.

With the second scheme, licenses are used to limit the number of users who can access an application. These licenses are commonly referred to as “user-based licenses.” A user-based license is associated with a user who is permitted to use the application. Again, assume that the developer provides a code that needs to be entered when the application is initially accessed by a user. In such a scenario, an identifier that is representative of the user may be programmatically associated with the license permitting use of the application. An example of a user identifier is a credential, such as an email address or alphanumeric code (e.g., that is representative of a company identifier), and corresponding password. Together, the credential and password may allow the user to sign into the application and then use its services in accordance with the license.

### BRIEF DESCRIPTION OF THE DRAWINGS

FIG. 1 illustrates a network environment that includes a digital distribution platform.

FIG. 2 includes an example of an interface that lists the applications available to the user as a member of the tenant(s) to which the user currently belongs.

FIG. 3 includes an example of an interface that provides details for an application included in a library.

FIG. 4 includes an example of an interface that lists all of the instances that are owned by the user who is presently signed into the platform.

FIG. 5 includes an example of an interface that provides details regarding an instance of an application.

FIG. 6 includes an example of an interface that provides details about a primary interface associated with an instance of an application.

FIG. 7 includes an example of an interface that provides details about a secondary interface associated with an instance of an application.

FIG. 8 includes an example of an interface that lists all of the interfaces—both primary and secondary—for which the user is the operator.

FIG. 9 includes an example of an interface that shows a dialog box for creating a new instance of an application.

FIG. 10 shows a dialog box for creating a new secondary interface that is associated with an instance of an application.

FIG. 11 shows a dialog box for assigning a secondary interface associated with an instance of an application to another user.

FIG. 12 includes a block diagram that illustrates how a secondary interface can be created for an instance by calling a function (e.g., iface_add( )) through the corresponding application's application programming interface (API).

FIG. 13 includes a block diagram that illustrates how the secondary interface can be assigned from a first user (also called the “owner”) to a second user who is able to serve as the operator by calling a function (e.g., iface_assign( )) through the corresponding application API.

FIG. 14 includes a block diagram that illustrates how the secondary interface can be “reclaimed” by calling a function (e.g., iface_reclaim( )) through the corresponding application API.

FIG. 15 includes a block diagram that illustrates how the secondary interface can be released, based on an initiation by the assignee (i.e., the second user), by calling a function (e.g., iface_release( )) through the corresponding application API.

FIG. 16 includes a block diagram that illustrates how the secondary interface can be deleted by calling a function (e.g., iface_delete( )) through the corresponding application API.

FIG. 17 includes a block diagram that illustrates how a platform module can be implemented in an application client.

FIG. 18 includes a block diagram that illustrates how, in operation, calls can be routed through the platform server, though responses may appear to come from the application server from the perspective of the application client.

FIG. 19 includes a flow diagram of a process for determining, in a dynamic manner, whether to instantiate a new instance of an application in response to receiving a request to do so.

FIG. 20 is a flow diagram of a process for dynamically addressing requests from members of a tenant to utilize an application.

FIG. 21 includes a flow diagram of a process for creating a tenant and then managing the dynamic instantiation and termination of instances of an application on behalf of the tenant.

FIG. 22 includes a flow diagram of a process for allocating licenses for an application on a per-instance basis.

FIG. 23 includes a flow diagram of a process for dynamically allocating licenses as necessary to accommodate utilization by members of a tenant.

FIG. 24 includes a flow diagram of a process for dynamically allocating licenses for an application to members of a tenant.

FIG. 25 is a block diagram illustrating an example of a processing system in which at least some operations described herein can be implemented.

Various features of the technology described herein will become more apparent to those skilled in the art from a study of the Detailed Description in conjunction with the drawings. Various embodiments are depicted in the drawings for the purpose of illustration. However, those skilled in the art will recognize that alternative embodiments may be employed without departing from the principles of the technology. Accordingly, although specific embodiments are shown in the drawings, the technology is amenable to various modifications.

### DETAILED DESCRIPTION

Conventional licensing schemes have advantages and disadvantages. Device- and user-based licenses generally satisfy the needs of the developers responsible for creating applications, as well as the distribution platforms that facilitate delivery of the applications. However, these licensing schemes tend to leave users at a disadvantage.

Consider device-based licenses, for example. With a device-based license, a user will not be able to access the application if the licensed computing device is not available or if the licensed computing device malfunctions. Replacing a computing device may not only be time consuming, but also tedious because the license has to be transferred to a new computing device. This process can (and often does) require that the developer be contacted to assist. Device-based licenses can also lead to “lock in” of vendors or ecosystems due to the difficulty of transferring licenses.

User-based licenses address several of these problems, especially since user-based licenses are commonly issued for applications that are delivered via the Software-as-a-Service (“SaaS”) model where download is not necessary. Instead, a user may be able to access an application through a client (e.g., a web browser) that is executing on her computing device, while the application is executed by a cloud computing infrastructure.

User-based licenses are not without problems, however. All users who need to use an application are required to register with the developer, and each user will consume a single license. For large groups of users (e.g., employees of a company), this tends to be wasteful since the average number of users that concurrently access the application is normally much lower than the total number of licenses purchased. As an example, a company with 500 employees may purchase 500 licenses to use a video teleconferencing application (e.g., supported by Zoom Video Communications Inc., Webex by Cisco, or Microsoft) even though a small subset of those employees will need to use the video teleconferencing application at any given point in time. Because licenses are assigned on a per-user basis, the licenses associated with users who are not currently accessing the video teleconferencing application cannot be used to allow someone else to access the video teleconferencing application, even for a short period of time. Even attempting to accomplish this is impractical, as transferring or revoking the license associated with a particular user (e.g., when the particular user leaves the company) is a tedious process that, once again, may require the developer be contacted.

Introduced here, therefore, is a digital distribution platform that associates licenses with instances of applications rather than users or computing devices. As further discussed below, the digital distribution platform may facilitate distribution of applications that reside on a cloud computing infrastructure. While these “cloud-native” applications may be implemented on the cloud computing infrastructure, the digital distribution platform can provide a convenient source through which to access these cloud-native applications.

One benefit of the digital distribution platform is its ability to allow for dynamic instantiation and termination of instances of an application. Assume, for example, that a user wishes to use an application for a relatively brief period of time (e.g., several hours or days). In this scenario, the user may be able to instantiate an instance of the application through an interface generated by the digital distribution platform, use the instance as needed over the brief period of time, and then terminate the instance when she is finished. Through this approach, the user can avoid long-term commitments and obligations.

Because instances of applications can be instantiated and terminated on demand, the licenses permitting use of the applications can be dynamically assigned to instances rather than users or computing devices. Accordingly, the digital distribution platform may assign a license to an instance in response to receiving input indicative of a request to instantiate the instance. Then, upon receiving input indicative of a request to terminate the instance, the digital distribution platform may revoke the license from the instance. This license can then be reassigned to another instance as necessary.

At a high level, the digital distribution platform may maintain a “pool” of licenses for an application. Licenses in the “pool” can be assigned to instances as those instances are created, and as instances are terminated, the corresponding licenses can be repopulated into the “pool.” In the event that interest in an application exceeds the number of licenses (e.g., based on a determination that more instances have been requested than licenses exist in the “pool”), the digital distribution platform can add licenses to the “pool.” Similarly, the digital distribution platform could remove licenses from the “pool”—thereby releasing licenses back to the developer—in the event that interest in the application consistently falls below the number of licenses in the “pool.”

Notably, this approach to assigning licenses to instances rather than users or computing devices allows sharing to be under the control of each instance owner rather than the provider of the application. Sharing is discussed in greater detail below. Simply put, because licenses are assigned to instances, those instances can be readily reassigned without experiencing the problems associated with per-device and per-user licenses. Users of the digital distribution platform may not only be able to access their instances using any computing device, but may also be able to share their instances with anyone, so long as the number of concurrent users per instance does not exceed the limits set by the respective licenses.

### Terminology

References in the present disclosure to “an embodiment” or “some embodiments” means that the characteristic, feature, or structure being described is included in at least one embodiment. Occurrences of such phrases do not necessarily refer to the same embodiment, nor do they necessarily refer to alternative embodiments that are mutually exclusive of one another.

The term “based on” is to be construed in an inclusive sense rather than an exclusive sense. That is, in the sense of “including but not limited to.” Thus, the term “based on” is intended to mean “based at least in part on” unless otherwise noted.

The terms “connected,” “coupled,” and variants thereof are intended to include any connection or coupling between two or more elements, either direct or indirect. The connection or coupling can be physical, logical, or a combination thereof. For example, elements may be electrically or communicatively connected to one another despite not sharing a physical connection.

The term “module” may refer broadly to software, firmware, hardware, or combinations thereof. Modules are typically functional components that generate one or more outputs based on one or more inputs. A computer program may include or utilize one or more modules. For example, a computer program may utilize multiple modules that are responsible for completing different tasks, or a computer program may utilize a single module that is responsible for completing multiple tasks.

When used in reference to a list of items, the word “or” is intended to cover all of the following interpretations: any of the items in the list, all of the items in the list, and any combination of items in the list.

The term “application” may refer to a computer software package that is designed to perform, facilitate, or support a function for a user. An application may be self-contained, or an application may be representation of a collection of different computer programs. Examples of applications include word processing programs, database management programs, image editing programs, communication platforms (e.g., designed for email or messaging), and the like.

### Overview of Digital Distribution Platform

The digital distribution platform (or simply “platform”) can operate as a multi-tenant system. Groups of users—referred to as “tenants”—can be provided with their own respective environments that are completely isolated from each other. Assume, for example, that a company is interested in having its employees access a given application that is available through the platform. In such a scenario, the employees of the company may correspond to the same “tenant.” Because tenants are isolated from one another, the users corresponding to one tenant (e.g., Company A) may be oblivious to the face that other tenants (e.g., Companies B, C, and D) coexist on the platform.

As mentioned above, each tenant can be provided with its own respective environment. This environment may define the applications that are accessible to users associated with the corresponding tenant. For example, in an embodiment where a tenant is defined to include at least some employees of a company, those employees may be permitted to access one or more applications through the platform. These application(s) may be a subset of those accessible through the platform, but may be the only ones selected by an administrator of the tenant. The administrator is normally an employee of the company, such as a member of the human resources department or information technology department. At a high level, the administrator may be responsible for determining which individuals are part of the corresponding tenant, as well as which applications are accessible to those individuals.

For simplicity, these groups of users may simply be referred to as “tenants.” However, because inclusion in each tenant is restricted by the corresponding administrator, these groups of users may be more accurately described as “private tenants.” The platform may also support a more broadly available tenant—referred to as a “public tenant”—that is available for individuals who are interested in using the platform but are not part of a private tenant. As an example, an independent contractor who completes crowdsourced tasks but does not work for a single company may not be part of any private tenants. However, this person may still be able to utilize the platform through the public tenant. Like the private tenants, the public tenant may also have an administrator, though the administrator may be an employee of the company that develops, manages, or otherwise supports the platform.

Additional tenants could be created in an ad hoc manner to meet the needs of individual users and companies. Assume, for example, that a company is currently associated with a first tenant that includes a first set of employees who are permitted to utilize a first application, and then the company determines that at least some of its employees require use of a second application. In such a scenario, the platform can define, for the company, a second tenant that includes a second set of employees who are permitted to utilize the second application. The first and second sets of employees could partially or entirely overlap (e.g., where the first set includes all employees and the second set includes employees in a particular group or role). Alternatively, the first set of employees may be entirely distinct form the second set of employees (e.g., where the first set includes employees in one group or role and the second set includes employees in another group or role).

An individual that belongs to a tenant may be called a “member” of that tenant, in addition to being called a “user” of the platform. For each tenant, the platform may maintain a member directory (or simply “directory”) that lists the digital profiles of the members. In some embodiments, the directory is accessible to the members of the corresponding tenant. Accordingly, a user may be able to use the directories of tenants of which she is a member to communicate with other users of the platform. Generally, the directory is a compilation of employee contact information in the case of a private tenant. For the public tenant, the directory may be a compilation of information, if any, that each member has decided to make public. In the event that a user opts to join the public tenant during a registration process, the user may be prompted to specify what information, if any, she would like to make available to other members of the public tenant. This information could include name, interests, contact details (e.g., phone number or email address), and the like.

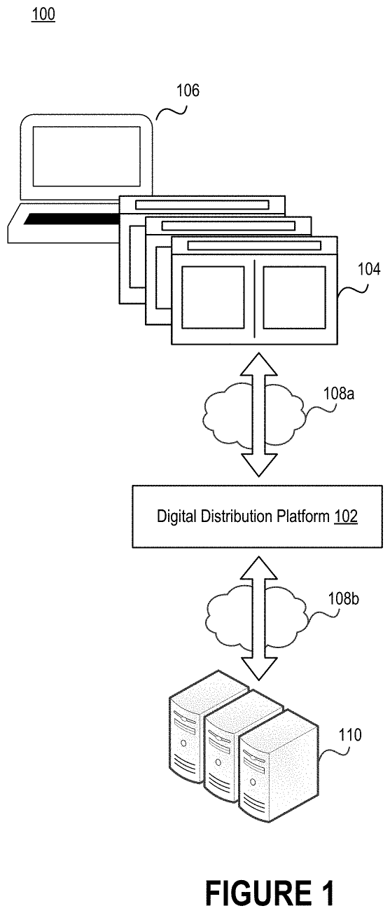

FIG. 1 illustrates a network environment 100 that includes a digital distribution platform 102. Users can interface with the platform 102 via interfaces 104. For example, a user may be able to access an interface through which she can select and then use an application. As shown in FIG. 1, these interfaces 104 may be accessible via a client that is executing on a computing device 106. While the computing device 106 is associated with, and accessible to, the user, the computer device 106 may be provisioned or provided by another entity, such as an employer of the user.

The interfaces 104 may be accessible via a web browser, mobile application, or desktop application. For example, in order to run an instance of an application as further discussed below, a user may access an interface that is generated by a web browser executing on the computing device 106. Through this interface, the user may select the application and then provide input indicative of instructions to the application. While the computing device 106 is depicted as a laptop computer, the interface 104 may be accessible via other computing devices, such as mobile phones, tablet computers, wearable electronic devices (e.g., watches and fitness accessories), virtual or augmented reality systems (e.g., head-mounted displays), and the like.

As shown in FIG. 1, the platform 102 resides in a network environment 100. Thus, the computing device on which the platform 102 is implemented may be connected to one or more networks 108a-b. These networks 108a-b may be personal area networks (“PANs”), local area networks (“LANs”), wide area networks (“WANs”), metropolitan area networks (“MANs”), cellular networks, or the Internet.

In some embodiments, at least some components of the platform 102 are hosted locally. That is, part of the platform 102 may reside on the computing device 106 that is used to access the interfaces 104. For example, the platform 102 may be partially embodied as a desktop application that is executable by the computing device 106. Note, however, that the desktop application may be communicatively connected to a cloud computing infrastructure 110 on which other components of the platform 102 are hosted.

In other embodiments, the platform 102 is executed entirely by the cloud computing infrastructure 110. The cloud computing infrastructure 110 may be operated by, for example, Amazon Web Services®, Google Cloud Platform™, or Microsoft Azure®. In such embodiments, the platform 102 may reside on cloud computing infrastructure 110 that is comprised of computer servers. These computer servers can include different types of data (e.g., login credentials, licenses, permissions), applications, and other assets. Those skilled in the art will recognize that this information could also be distributed amongst the cloud computing infrastructure 110 and one or more computing devices. For example, some data that is generated through use of an application executing on the cloud computing infrastructure 110 may be stored in memory that is accessible to a company whose employees are using the application. This memory may be included in the cloud computing infrastructure 110, or this memory may be accessible to the cloud computing infrastructure 110 (e.g., via the Internet).

### Overview of Application Library

At a high level, an application is a software package that is able to perform a set of defined tasks for a user (or, in some cases, for another application). An application may include a single module that supports a single functionality, or an application may include multiple modules that support different, though sometimes related, functionalities. Generally, each module corresponds to a distinct instruction set that is independently executable.

The platform can maintain per-tenant libraries of applications that are available for members to use. While a large number (e.g., more than 20, 30, or 50) applications may be accessible through the platform, each library may include a subset of those applications. For example, the platform may maintain a first library that includes a first set of applications for a first tenant and a second library that includes a second set of applications for a second tenant. The first set may include a different number of applications than the second set. Moreover, the first set may include entirely different applications than the second set, though the first and second sets could share applications in common.

Note that while each member of a tenant may be permitted to utilize any application included in the library maintained for the tenant, members may not necessarily use those applications. Consider, for example, the situation mentioned above in which the platform maintains a first library that includes a first set of applications for a first tenant. While a member of the first tenant may be able to use any application included in the first set, the member is not obligated to use the applications in the first set. The member may be permitted to use any application in the first set as necessary.

Because applications can (i) reside on the same cloud computing infrastructure as the platform and (ii) be maintained in the form of libraries on a per-tenant basis, updates can be readily implemented by the platform. For example, each application can be updated by the platform whenever a newer version is released by the developer. Similarly, the platform can update each library when new applications become available or when new versions of existing applications are released.

As further discussed below, a user may be able to interface with the platform through interfaces that are accessible through a client. The client could be, for example, a web browser, mobile application, or desktop application that is executed locally (i.e., by the computing device used by the user to access the client). Because the client enables the user to interact with the platform without executing the applications, it may be referred to as a “thin client.”

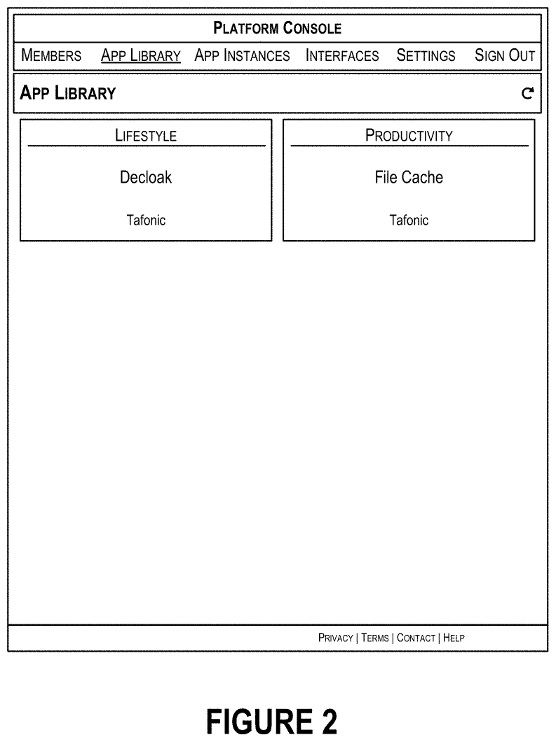

To initiate an application, the user may simply select the application from among those that have been made available to her by the platform through an interface. FIG. 2 includes an example of an interface that lists the applications available to the user as a member of the tenant(s) to which she currently belongs. Upon receiving input indicative of a selection of the application, the platform can create an instance of the application. Said another way, the platform can instantiate the application in response to a determination that the user has indicated she would like to use the application.

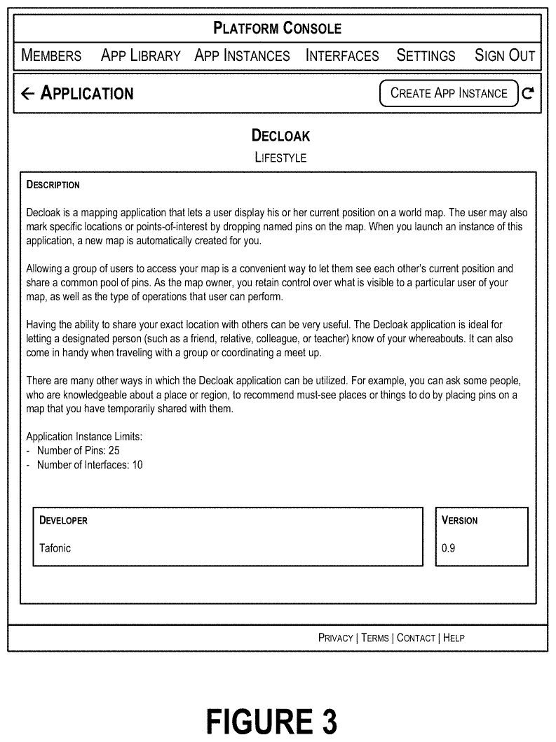

In some embodiments, the user can be shown details for the applications included in the library. For example, details may be provided for an application in response to a determination that the user selected the application (but has not yet requested that an instance of the application be created). FIG. 3 includes an example of an interface that provides details for an application included in a library.

The instance can be run by the cloud computing infrastructure on which the platform resides, and therefore the user does not need to be concerned with installing the application on her own computing device or upgrading the application from time to time. Instead, whenever the user opts to instantiate an application, the platform can create an instance of the application that is representative of its most recent version.

Each instance created by the platform is a running copy of an application, for example, that was selected from a library by a user. One benefit of this approach, in which instances can be dynamically created and then terminated, is that a single user may be permitted to create multiple instances at the same time. For example, a user may create an instance of an application designed as a business communication program and an instance of another application designed as a calendar management program. In this situation, the user can use those instances to perform different tasks. Moreover, a user may be permitted to create multiple instances of the same application. In such a scenario, the application state can be partitioned into multiple units that can be managed independent of one another. For example, a user may create a first instance of an application designed as a calendar management program to manage work deadlines and a second instance of the same application to manage personal deadlines. Each instance may be run independently by the platform, regardless of whether instances relate to the same application or different applications. Accordingly, each instance may be completely isolated from other instances, if any, created by the user.

Another benefit of creating additional instances is that users can easily navigate around the scaling and capacity restrictions of applications offered through conventional approaches. As an example, the application store model does not allow users to install and run multiple copies of the same application on a single computing device. Accordingly, users have to live with scaling and capacity limitations imposed by the application. The same is also true of the SaaS model. For both models, portioning the application state would require inherent support from the application itself, which greatly increases complexity (and therefore decreases the likelihood of implementation by the developer). While a user could opt to create multiple accounts for applications offered through the SaaS model in an effort to circumvent the aforementioned issues, this is not ideal due to the additional complexity of managing multiple accounts (in addition to the additional costs required for the multiple accounts). This is especially true if the multiple accounts are only needed for a short period of time (e.g., several hours or days).

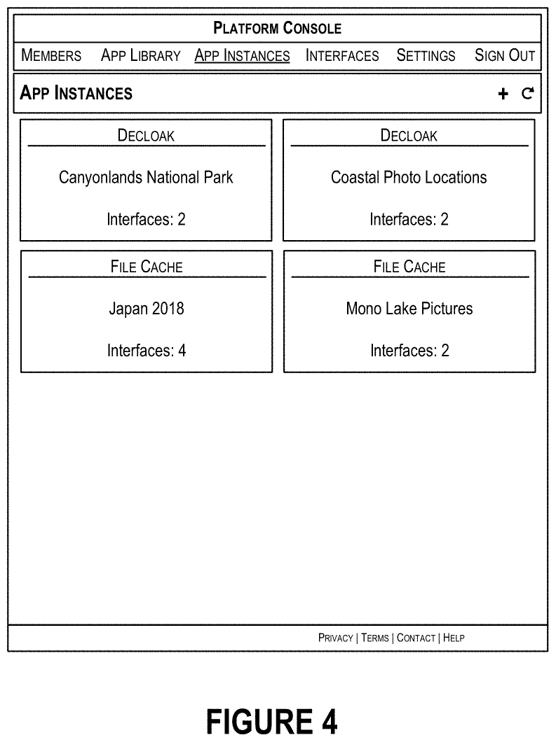

When a user accesses the platform, she may be able to view the instances that she presently “owns.” FIG. 4 includes an example of an interface that lists all of the instances that are owned by the user who is presently signed into the platform. These instances may have been created by the user, for example, through the instantiation process described above. Additionally or alternatively, these instances may have been transferred to the user by other users. For example, an instance may be transferred from a first user to a second user (e.g., by the administrator of the tenant of which those users are members) when the first user leaves the company, the second user joins the company, the job responsibilities of the first user or second user change, etc.

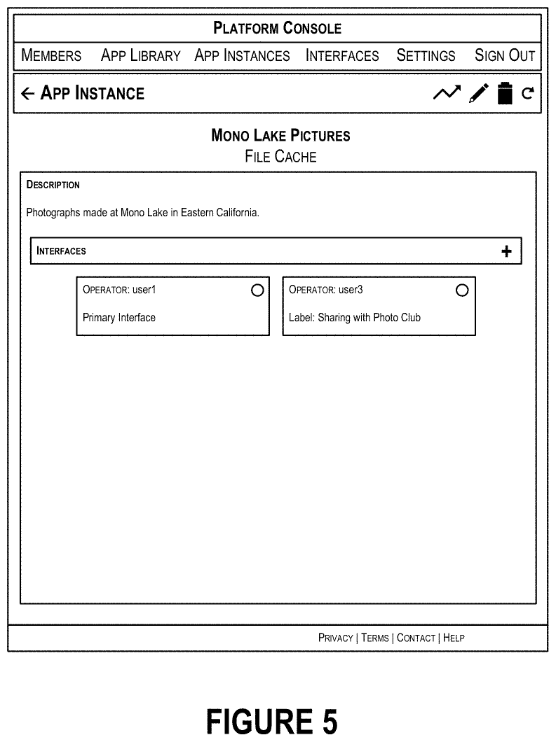

As mentioned above, the user may be able to view details regarding an application that is accessible through the platform as shown in FIG. 3. Additionally, the user may be able to view details regarding a particular instance of an application. FIG. 5 includes an example of an interface that provides details regarding an instance of an application.

When an instance is no longer needed, it can be terminated by the platform. Consider, for example, the aforementioned example in which the user creates a first instance of an application to manage work deadlines and a second instance of the application to manage personal deadlines. At some point in time, the user may indicate that one of these instances is no longer needed. For example, the user may have created the second instance of the application to help with tracking deadlines of personal interest associated with a time-limited event. Examples of time-limited events include holidays and vacations. After the time-limited event has occurred, the user may request that the second instance of the application be deleted. This could be done through an interface generated by the platform (e.g., by selecting an option labeled “Terminate Instance,” “Delete Instance,” or “Close Instance”). In response to receiving input indicative of a request to delete the instance, the platform can terminate the instance. After the instance is terminated, the user may not be able to access the application without requesting that a new instance be created as discussed above.

### Overview of Interfaces

In order to permit interaction with an instance of an application, the platform may generate an interface. At a high level, the interface may be a special construct through which a user is able to interact with the instance. The interface allows the user to start the appropriate application user interface (UI) and then connect it to the instance. Only the designated operator of an interface may be allowed to use the interface. Accordingly, each interface may be associated with, and able to receive input from, a single user.

In operation, the platform can construct two different kinds of interfaces, namely, primary interfaces and secondary interfaces. Each type of interface is discussed in greater detail below.

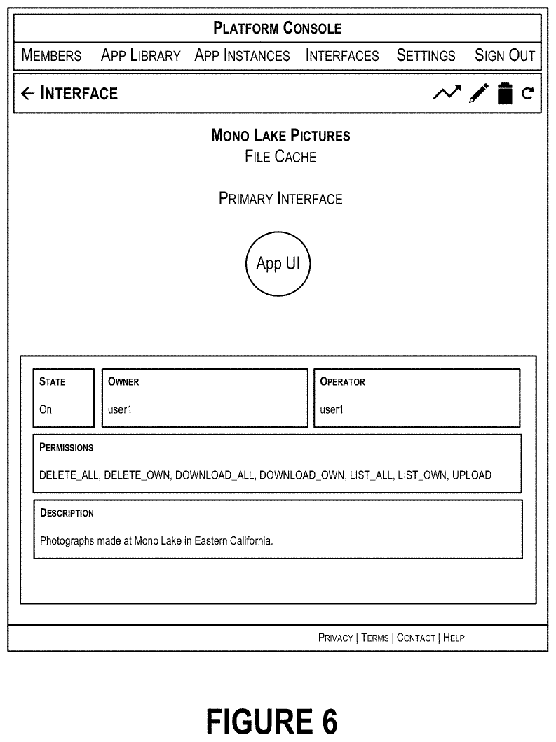

A primary interface is a special interface that can be automatically created as part of the instance creation process. For example, in response to receiving input indicative of a request to create an instance of an application, the therapy platform may create the instance and primary interface. The interface and primary interface may be created sequentially or simultaneously. Generally, the primary interface created for an instance cannot be disabled or deleted. Importantly, the primary interface may have the necessary permissions to perform all of the operations supported by the instance. Said another way, any operation supported by the instance can be performed through the primary interface. Only the owner of the instance may be allowed to operate its primary interface. FIG. 6 includes an example of an interface that provides details about a primary interface associated with an instance of an application.

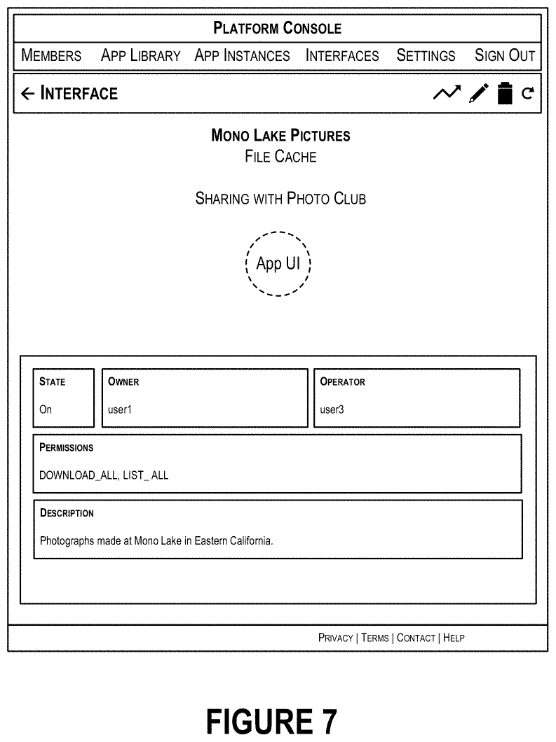

In some situations, the owner of an instance may want to attach one or more additional interfaces to it. As an example, the owner may want to attach an additional instance if she wants another user to be able to interact with the instance created for the owner. These additional interfaces are called “secondary interfaces.” Each secondary interface can be temporarily assigned to another user by the owner. Generally, these other users are members of the same tenant as the owner. A user who received a secondary interface becomes its new operator. The user can then use the secondary interface to interact with the instance created for the owner. The type and scope of operations that can be performed through each secondary interface may be determined by the permissions that have been specified for that secondary interface. The owner may be prompted to specify the permissions when she indicates that she would like to create the secondary interface (and thus, while the secondary interface is being created). FIG. 7 includes an example of an interface that provides details about a secondary interface associated with an instance of an application.

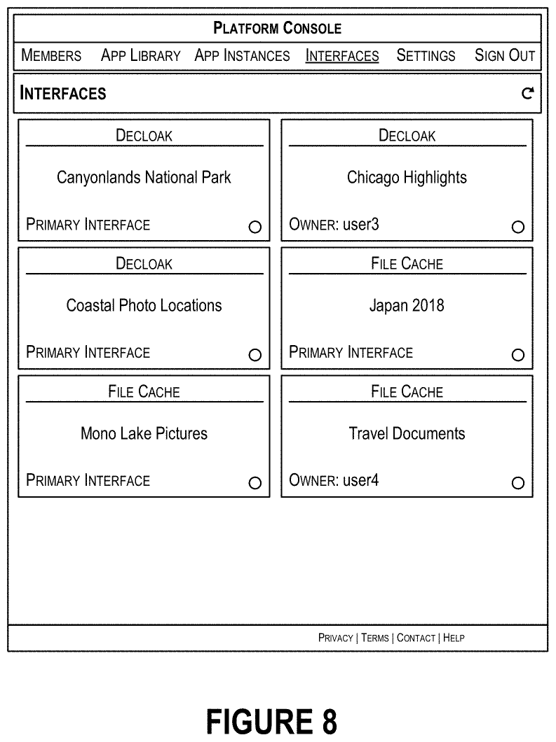

By creating one or more secondary interfaces for an instance and then sharing those secondary interfaces with other users, the platform provides a safe and convenient way to share the instance. Simply put, the platform gives users the freedom to decide who can use each instance, in what manner, and for how long. Allowing multiple users to work together through the provisioning and assigning of secondary interfaces also reduces the likelihood of unauthorized access of the instance and data stored therein. Credentials for accessing the instance do not need to be shared among the users, and the users do not need to separately download the application. FIG. 8 includes an example of an interface that lists all of the interfaces—both primary and secondary—for which the user is the operator. These interfaces may be owned by the user, or these interfaces may have been assigned to the user by other users.

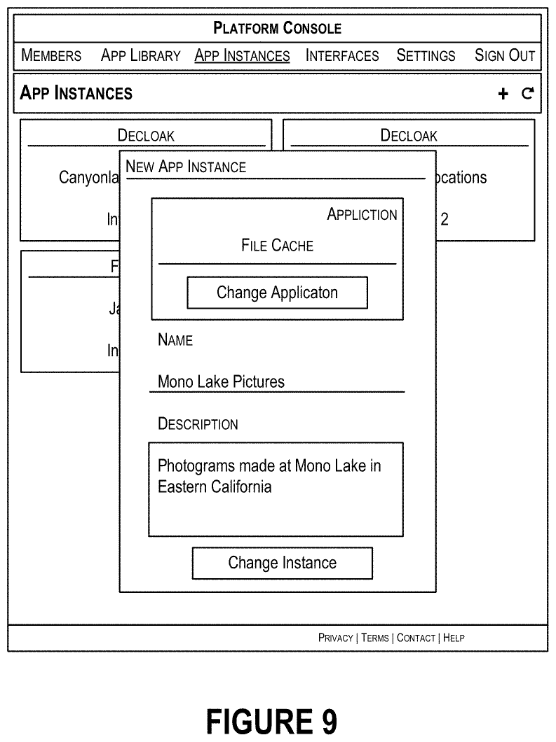

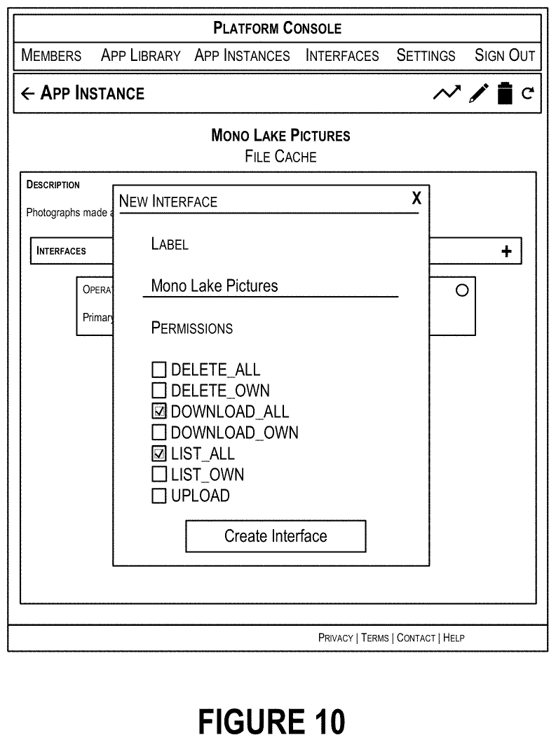

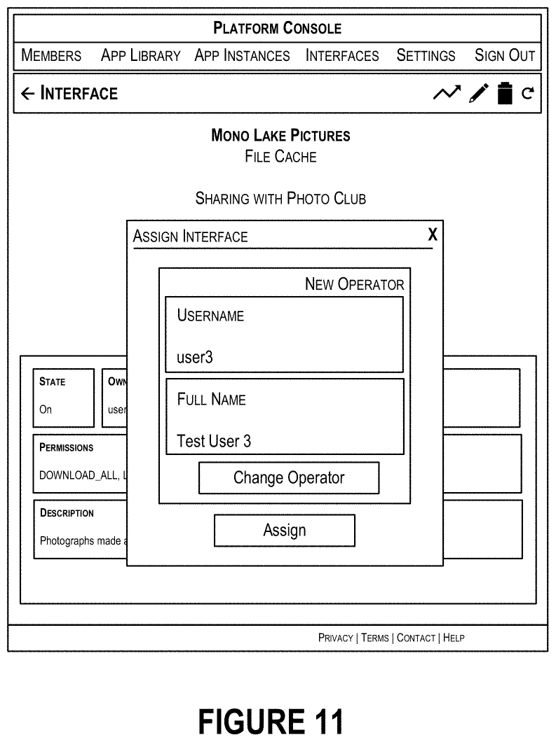

FIGS. 9-11 show how interfaces can be created and then assigned to users. Specifically, FIG. 9 includes an example of an interface that shows a dialog box for creating a new instance of an application. As mentioned above, the platform may automatically generate a primary interface as the new instance is created. FIG. 10 shows a dialog box for creating a new secondary interface that is associated with an instance of an application. FIG. 11 shows a dialog box for assigning a secondary interface associated with an instance of an application to another user. Generally, this other user will be another member of the same tenant of which the originating user is a member.

Accordingly, the workflow implemented by the platform to share an interface may be generally characterized as having four steps. First, the platform can create a secondary interface by attaching a new interface to the instance of the application. Second, the platform can assign the secondary interface to another user, so as to grant access to the secondary interface. Third, the platform can reclaim the secondary interface, so as to revoke access to the instance from the other user. And fourth, the platform can delete the secondary interface when it is no longer needed. Note that the permissions set on the secondary interface may determine the type and scope of operations that the other user (also called the “assignee”) can perform on the instance of the application.

### Overview of Platform Architecture

Embodiments of the platform may be based on a client-server model, in which a computer server that supports the platform resides in the cloud while client programs (or simply “clients”) for accessing the platform can be executed by computing devices managed by users. The computer server (also called the “platform server”) may comprise several loosely coupled infrastructure elements. Examples of infrastructure elements include compute units, databases, object storage volumes, messaging services, and the like. The platform server may be responsible for managing all of the tenants, users, applications, instances, and interfaces that exist on the platform. The platform server may export an API that defines the total sum of its capabilities.

Different kinds of clients may be supported by the platform. For example, the platform may support (i) a command-line interface that provides a command line and (ii) a console interface that provides a simple interface (e.g., designed for web browsers). Clients—which may be located anywhere—can use the API to communicate with the platform server via the Internet.

Each application that is included in a library (and thus, accessible from the platform) may also be based on the client-server model. A computer server (also called the “application server”) may reside in the cloud similar to the platform server. The application server may be responsible for creating and maintaining all instances of the application. Note that each application could be supported by a different application server, or a single application server could support multiple applications. The application server may be able to export an application API that comprises (i) methods, rules, or heuristics for the platform server to interact with the application server, and/or (ii) methods, rules, or heuristics for application clients to interact with the application server.

An application client (also called an “application UI”) may be embodied as a browser-suitable interface for interacting with an instance of an application. The application client may be started by the console interface when a user indicates that she wishes to interface with an instance. Generally, the application client cannot directly invoke the application API. Instead, the application client may rely on a platform module to post requests to the application API (e.g., via the platform server) and convey responses.

The application server may be responsible for creating all instances of the application, as well as maintaining their respective runtime states and data. Each application server may be responsible for implementing or supporting two methods—namely, appinst_add( ) and appinst_delete( )—as part of its application API. When the platform server receives a request to create or delete an instance of an application from a platform client, the platform server can forward that request to the appropriate application server by invoking appinst_add( ) or appinst_delete( ) of the corresponding application API. The corresponding application API may be identified by the platform server based on an analysis of the request that specifies the application.

The platform server can maintain metadata for each instance that is created. The information represented by the metadata may be used to perform validation or authorization checks, as well as support a variety of management operations. Examples of such management operations include the addition or deletion of an instance, listing an instance as belonging to a user or tenant, changing the name or description of an instance, transfer the ownership of an instance from one user to another user, and the like.

Managing the interfaces created for an instance is an important aspect of the user experience. The interfaces can be created and managed by the platform server. In some embodiments, the developer of an application may be able to specify how many interfaces—primary and secondary—are allowed. For example, the developer may limit the number of interfaces that can be associated with an instance by specifying an upper bound (also called the “per-instance interface limit”) for the application.

The platform server can maintain metadata for each interface that is created. The information represented by the metadata may be used to perform validation or authorization checks, as well as support a variety of management options. Examples of such management operations include the addition or deletion of an interface, listing the interfaces associated with a given instance, enabling or disabling an interface, changing the permissions set for an interface, assigning an interface from one user to another user, reclaiming an interface from the current assignee, listing all of the interfaces that a given user can operate, and the like.

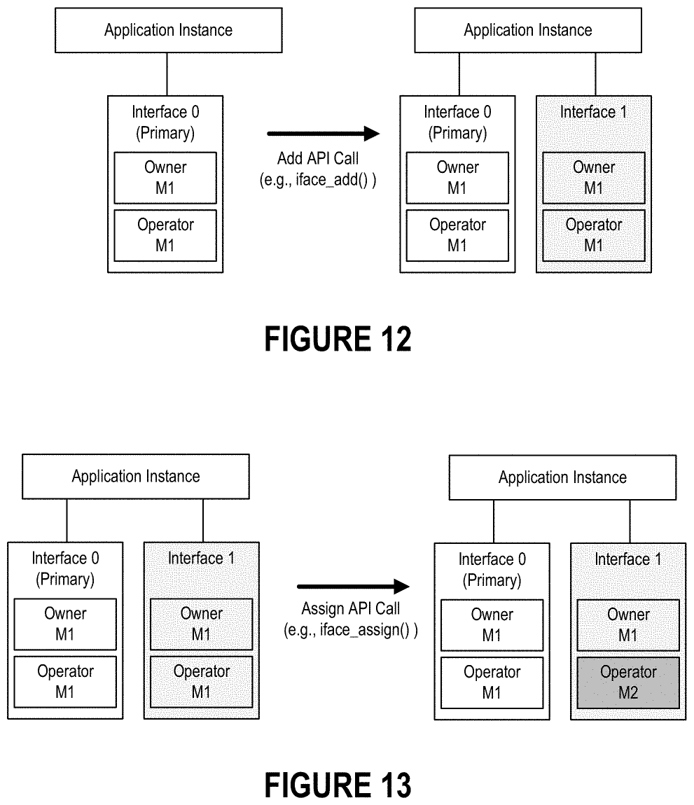

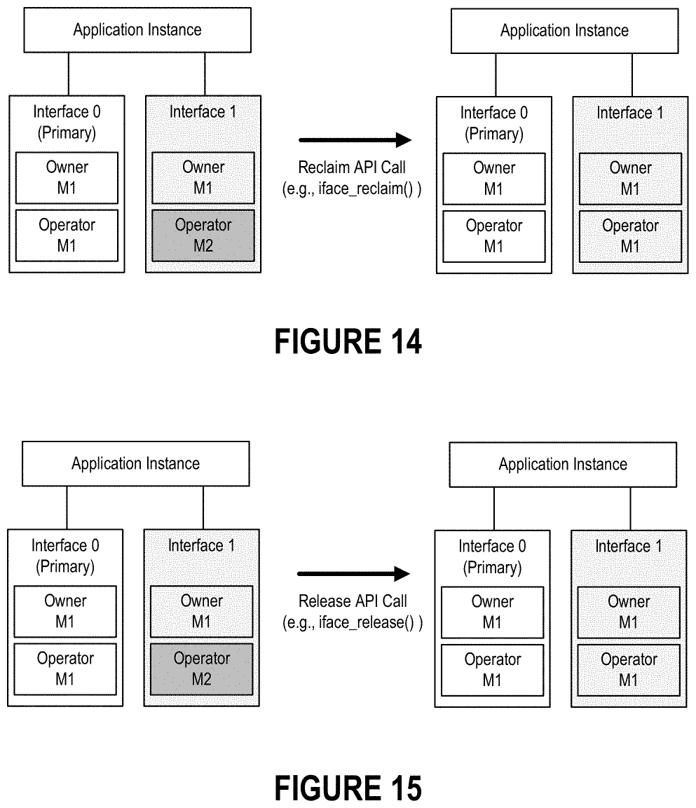

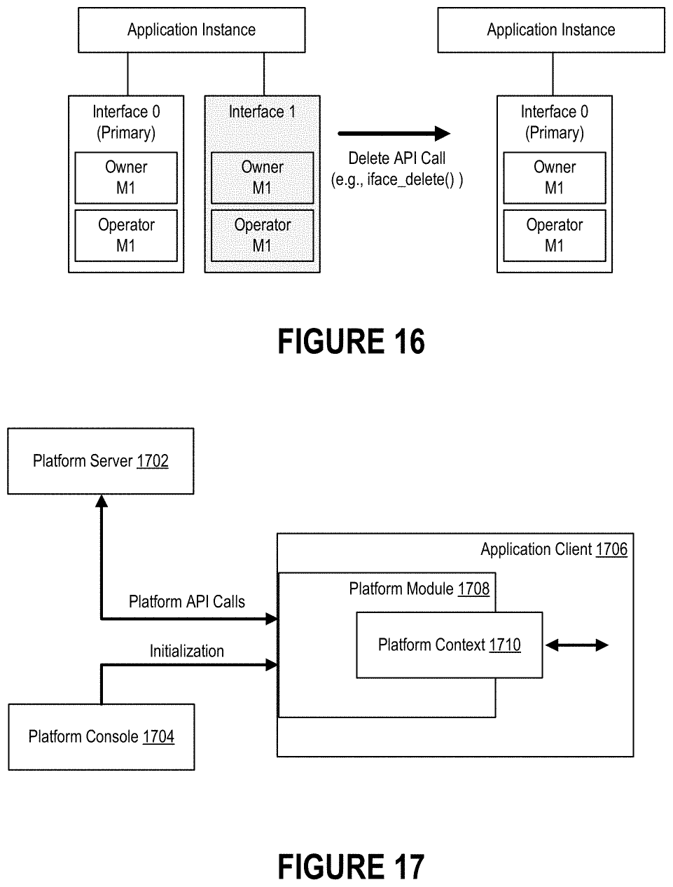

FIG. 12 includes a block diagram that illustrates how a secondary interface can be created for an instance by calling a function (i.e., iface_add( )) through the corresponding application API. FIG. 13 includes a block diagram that illustrates how the secondary interface can be assigned from a first user (also called the “owner”) to a second user who is able to serve as the operator by calling a function (i.e., iface_assign( )) through the corresponding application API. FIG. 14 includes a block diagram that illustrates how the secondary interface can be “reclaimed” by calling a function (i.e., iface_reclaim( )) through the corresponding application API. When the secondary interface is “reclaimed,” the first user can be reestablished as its operator. FIG. 15 includes a block diagram that illustrates how the secondary interface can be released, based on an initiation by the assignee (i.e., the second user), by calling a function (i.e., iface_release( )) through the corresponding application API. FIG. 16 includes a block diagram that illustrates how the secondary interface can be deleted by calling a function (i.e., iface_delete( )) through the corresponding application API. As mentioned above, the primary interface may remain “alive” so long as the instance is also “alive.”

### Overview of Platform Module

Applications can be more easily added to the platform if those applications are designed with the intent that those applications will be made available through the platform. Rather than require that developers design applications that are specific to the platform, developers may instead be requested to include a platform module in their applications. FIG. 17 includes a block diagram that illustrates how a platform module can be implemented in an application client. At a high level, the platform module is representative of a pre-built software component that, when included in an application, allows the application to be readily implemented by the platform. The platform may be provided to, or made accessible to, developers who are interested in building applications for the platform. One core purpose of the platform module is to transparently integrate the application client with the platform. The platform module may be able to interact with (i) the platform console, (ii) the platform server, and (iii) the application client.

In order for the application client to function correctly, the platform module may need to be initialized. Initialization may begin almost immediately after the application client has been started by the platform console. If the platform module cannot be initialized within a given timeframe (e.g., several seconds), then the platform console may terminate the application client. In this situation, the initialization process may start over again. During the initialization process, the platform module may receive, from the platform console: (i) a tenant identifier, username, and access token of the interface operator; (ii) an instance identifier and name; and (iii) an interface identifier and permissions.

In order to provide the operator of an interface—whether primary or secondary—with a nice user experience, the application client may need to access certain platform-related information. The platform module may controllably expose this information via the platform content, which can include one or more read-only data fields. These read-only data fields may include an indication of initialization (i.e., indicating whether the platform context is initialized or not), an instance name, interface permissions, a username of an operator, and the like. Moreover, the platform context may support a function called invoke_app_api( ). This function may take two parameters—namely, app_api_method and app_api_params—as input, and the application client may need to use this function to call the application API.

The platform module can continuously monitor each interface, using the platform API, as it is being used. By continuously monitoring usage, actions can be taken proactively in response to a determination that a criterion has been met. For example, the application client may be terminated if any of the following are determined to be true: (i) the interface no longer exists, (ii) the interface has been disabled, (iii) the operator of the interface has changed, or (iv) the operator has signed out from the platform. The platform context, which is exposed to the application client, can be updated if any of the following are determined to be true: (i) the name of the instance has changed or (ii) the permissions for the interface have changed.

When an application client calls invoke_app_api( ) to send a request to the application API, the platform module can forward this request to the platform server. The platform module can use interface_operate( ) of the platform API to accomplish this. As input, interface_operate( ) may accept the following parameters: tenant identifier, instance identifier, interface identifier, app_api_method, app_api_params, or any combination thereof. As mentioned above, app_api_method and app_api_params may be received from the application client, for example, as parameters to the invoke_app_api( ) call. Meanwhile, the platform module may supply the tenant identifier, instance identifier, or interface identifier.

When the platform server receives an interface_operate( ) request, it may perform validation checks to ensure one or more conditions are true. Examples of such conditions include the following: (i) the caller of the API is signed into the platform, (ii) the instance and interface exist, (iii) the caller is the operator of the interface, and (iv) the interface is not disabled. Those skilled in the art will recognize that any combination of conditions could be employed for validation purposes. If the conditions are satisfied, the platform server can locate the endpoint of the appropriate application API and then invoke the requested function—namely, app_api_method—along with one or more of the following parameters: (i) tenant identifier, (ii) application identifier, (iii) operator username, (iv) interface permissions, and (v) app_api_params.

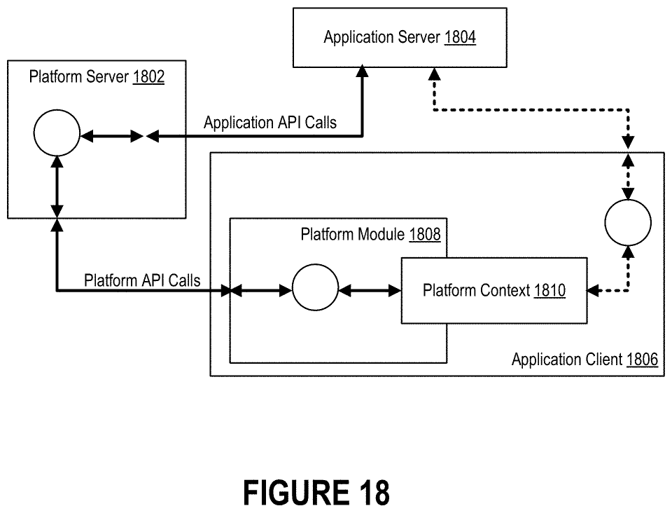

The return value of interface_operate( ) can include the response of the application API call. The platform module can then forward the response to the application client as the return value of invoke_app_api( ). Using interface_operate( ) to coordinate communication between an application client and the corresponding application server ensures that (i) the communication channel remains secure and reliable, (ii) the application client is connected to the appropriate instance, and (iii) only the designated operator of an interface can use the application client to interact with the instance. FIG. 18 includes a block diagram that illustrates how, in operation, calls can be routed through the platform server, though responses may appear to come from the application server from the perspective of the application client.

### Approaches to Dynamic Instantiation and Termination of Application Instances

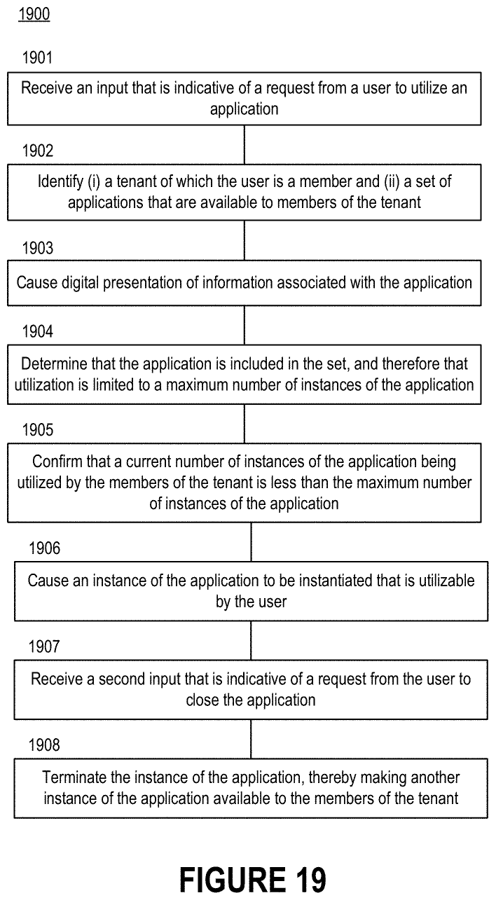

FIG. 19 includes a flow diagram of a process 1900 for determining, in a dynamic manner, whether to instantiate a new instance of an application in response to receiving a request to do so. Initially, a platform may receive input that is indicative of a request from a user to utilize an application (step 1901). As discussed above, this request may be submitted by the user through an interface generated by the platform and accessed via a computing device.

In response to receiving the input, the platform may identify (i) a tenant of which the user is a member and (ii) a set of applications that are available to members of the tenant (step 1902). For each application included in the set, utilization may be limited by the number of licenses that the tenant has for that application. For example, the tenant may have a first number of licenses for a first application, a second number of licenses for a second application, etc. As mentioned above, the tenant could be a private tenant or public tenant. In some embodiments, the platform causes digital presentation of information associated with the application in response to receiving the input (step 1903). The information could be digitally presented on the same interface through which the request is submitted by the user, for example. The information could include the maximum number of instances of the application, the number of members of the tenant that are currently utilizing at least one instance of the application, a description of the application, a version of the application, etc.

Thereafter, the platform may determine that the application is included in the set, and therefore that utilization is limited to a maximum number of instances for which licenses are available (step 1904). Said another way, the platform can establish that the application is included in the set, and therefore that the members of the tenant are permitted to utilize the application so long as licenses are available. The platform can then confirm that the current number of instances of the application being utilized by the members of the tenant is less than the maximum number of instances of the application (step 1905). If the current number of instances of the application being utilized by the members of the tenant is less than the maximum number of instances of the application—indicating that at least one license for the application remains available—the platform can cause an instance of the application to be instantiated that is utilizable by the user (step 1906).

As mentioned above, instances may not only be dynamically instantiable by the platform but also dynamically terminable by the platform. Accordingly, if the platform receives a second input that is indicative of a request from the user to close the application (step 1907), then the platform may terminate the instance of the application (step 1908), thereby making another instance of the application available to the members of the tenant.

Moreover, the platform may dynamically instantiate and terminate instances of the application in a user- and device-agnostic manner, such that a single user could instantiate multiple instances of the application on the same computing device or different computing devices. Assume, for example, that the platform receives a second input that is indicative of another request from the user to create a second instance of the application. In such a scenario, the platform may once again confirm that the current number of instances of the application being utilized by the members of the tenant is less than the maximum number of instances of the application and then cause the second instance of the application to be instantiated that is utilizable by the user. These instances of the application may be separately addressable by the user, such that use of one instance is independent from, and has no effect on, use of any other instances instantiated for the user.

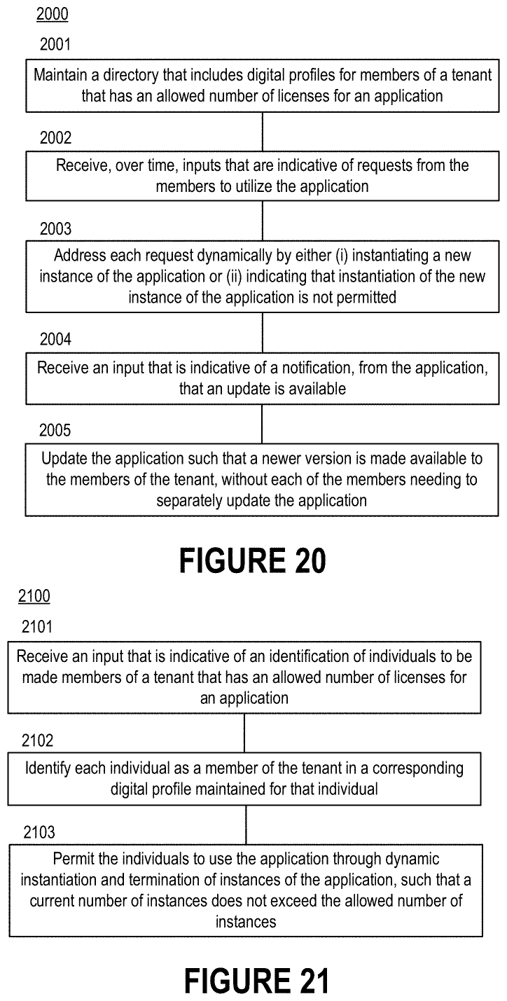

FIG. 20 is a flow diagram of a process 2000 for dynamically addressing requests from members of a tenant to utilize an application. As discussed above, a platform may maintain a directory that includes digital profiles for the members of the tenant that has an allowed number of licenses for the application (step 2001). Each digital profile may include information related to the corresponding member, though this information may vary depending on whether the tenant is a private tenant or public tenant. For example, if the tenant is a private tenant, the information may specify the name, contact information (e.g., email address and phone number), physical location (e.g., office number), position, and department within a company for which the tenant was created. Conversely, if the tenant is a public tenant, the information may specify the name and more limited contact information (e.g., email address or phone number), since the public tenant may include members that are unfamiliar with each other as discussed above.

Generally, the tenant has licenses for multiple applications and, therefore, the application may be one of multiple applications for which the tenant has licenses allowing use by its members. Requests by the members to use each of the multiple applications can be addressed independently by the platform. Moreover, requests can be addressed sequentially in a member-agnostic manner, such that a single member is able to provoke instantiation of multiple instances of the application on a single computing device or multiple computing devices.

Over time, the platform may receive inputs that are indicative of requests from the members to utilize the application (step 2002). These requests may be submitted by the members through respective interfaces accessed via respective computing devices. For each of the inputs, the platform can address the request dynamically by either (i) instantiating a new instance of the application or (ii) indicating that instantiation of the new instance of the application is not permitted (step 2003). Specifically, the platform may instantiate the new instance of the application in response to a determination that the current number of instances of the application is less than the allowed number of licenses, and the platform may indicate that instantiation of the new instance of the application is not permitted in response to a determination that the current number of instances is equal to the allowed number of licenses. The program can indicate that instantiation of the new instance of the application is not permitted by causing digital presentation of a notification that specifies the application is currently not available for use. In some embodiments, the notification specifies an expected timeframe in which the application is expected to be available for use. This expected timeframe may be computed by the platform by comparing the current duration of use of each instance to a historical average duration of use computed for the members of the tenant.

Note that, in some embodiments (e.g., where the tenant is a public tenant), the member may be permitted to communicate with other members through interfaces generated by the platform. For example, in the event that a given member is not permitted to utilize the application upon submitting a request to do so, the platform may permit the given member to communicate with other members of the platform. While communication generally occurs through interfaces generated by the platform, the platform could additionally or alternatively provide contact information (e.g., phone number or email address) to enable contact external to the platform.

Over time, the platform may update the application in a proactive manner to ensure that newer versions of the application are available to the members of the tenant without requiring any action by the members. For example, the platform may receive an input that is indicative of a notification, from the application, that an update is available (step 2004). In such a scenario, the platform may update the application such that a newer version is made available to the members of the tenant (step 2005), without each of the members needing to separately update the application. In some embodiments the application resides on the cloud computing infrastructure that executes the platform, while in other embodiments the application resides on another cloud computing infrastructure that is separate from, but accessible to, the cloud computing infrastructure that executes the platform.

FIG. 21 includes a flow diagram of a process 2100 for creating a tenant and then managing the dynamic instantiation and termination of instances of an application on behalf of the tenant. Initially, a platform may receive an input that is indicative of an identification of individuals to be made members of the tenant that has an allowed number of license for the application (step 2101). For example, a representative of a company may identify employees to be included in a private tenant that is created for the company. As another example, the platform may identify the individuals based on an analysis of a public tenant revealing that the individuals share an interest in utilizing the application.

Note that these individuals could be part of multiple tenants. Assume, for example, that a representative of a company creates multiple private tenants that include different subsets of employees of the company. In such a scenario, a single employee could be included in more than one private tenant.

For each of the individuals, the platform can identify that individual as a member of the tenant in a corresponding digital profile that is maintained for that individual by the platform (step 2102). For example, the platform may populate an identifier corresponding to the tenant into the digital profiles of the individuals. Then, the platform can permit the individuals to use the application through dynamic instantiation and termination of instances of the application, such that a current number of instances does not exceed the allowed number of licenses (step 2103).

### Approaches to Dynamic Allocation and Revocation of Licenses

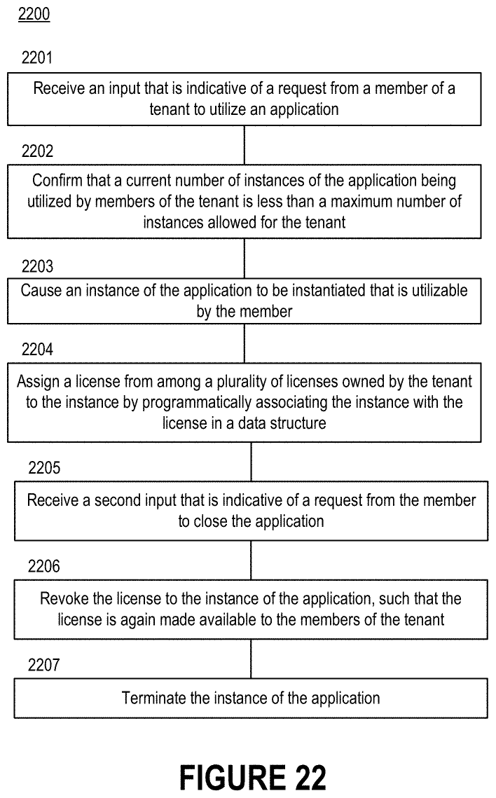

FIG. 22 includes a flow diagram of a process 2200 for allocating licenses for an application on a per-instance basis. Initially, a platform can receive an input that is indicative of a request from a member of a tenant to utilize an application (step 2201). Utilization of the application by members of the tenant may be limited to a maximum number of instances, which may be governed by the number of licenses that the tenant has for the application. Said another way, the tenant may be associated with a number of licenses that governs the maximum number of instances that are permitted. Then, the platform can confirm that the current number of instances being utilized by the members of the tenant is less than the maximum number of instances (step 2202). Steps 2201 and 2202 may be similar to steps 1901 and 1905, respectively, of FIG. 19.

After the platform has confirmed that the current number of instances of the application being utilized by the members of the tenant is less than the maximum number of instances, the platform can cause an instance of the application to be instantiated that is utilizable by the member (step 2203) and assign a license from among a plurality of licenses owned by the tenant to the instance by programmatically associating the instance with the license in a data structure (step 2204). As discussed above, such an approach causes the license to be assigned to the instance rather than the member who submitted the request or the computing device that is used by the member to submit the request.

Thereafter, the platform may receive a second input that is indicative of a request from the member to close the application (step 2205). In such a scenario, the platform may revoke the license to the instance, such that the license is again made available to the members of the tenant (step 2206), and the platform may terminate the instance of the application (step 2207).

As mentioned above, the platform may be able to dynamically manage the number of licenses associated with (e.g., owned by) the tenant based on the number of members that need to utilize the application. Consider, for example, a scenario where the platform receives a second input that is indicative of a request from a second member of the tenant to utilize the application, and the platform determines that the current number of instances of the application being utilized by the members of the tenant is equal to the maximum number of instances. Note that the second member could be the same person as the first member, or the second member could be a different person than the first member. In such a scenario, the platform may acquire another license for the application, to be included in the plurality of licenses to be made available to the members of the tenant, cause a second instance of application to be instantiated that is utilizable by the second member, and then assign the other license to the second instance with the other license in the data structure. Thus, the platform could dynamically acquire and then assign licenses if demand for the application exceeds the number of licenses associated with (e.g., owned by) the tenant.

Similarly, the platform could dynamically release licenses if demand for the application falls below the number of licenses associated with (e.g., owned by) the tenant. For example, if the platform determines that, over an interval of time (e.g., one week, one month, or three months), that utilization of the plurality of licenses by the members of the tenant falls below a threshold (e.g., 95 percent, 90 percent, or 80 percent), then the platform may cause at least one of the plurality of licenses to be released back to the developer of the application. The number of licenses that are released back to the developer may be based on the utilization of the plurality of licenses over the interval of time. For example, if the platform discovers that utilization is consistently below 80 percent over the course of one month, then the platform may release 20 percent of the available licenses for the tenant. Licenses could also be released in a more dynamic manner, for example, when a member instructs the platform to close the corresponding instance of the application, if allowed by the developer.

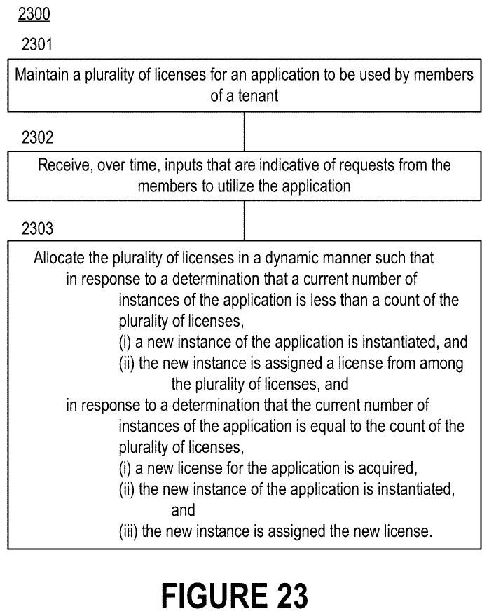

FIG. 23 includes a flow diagram of a process 2300 for dynamically allocating licenses as necessary to accommodate utilization by members of a tenant. As discussed above, a platform may maintain a plurality of licenses for an application to be used by members of a tenant (step 2301). Over time, the platform may receive inputs that are indicative of requests from the members to utilize the application (step 2302).

The platform can allocate the plurality of licenses in a dynamic manner such that in response to a determination that a current number of instances of the application is less than a count of the plurality of licenses, (i) a new instance of the application is instantiated and (ii) the new instance is assigned a license from among the plurality of licenses, and in response to a determination that the current number of instances of the application is equal to the count of the plurality of licenses, (i) a new license for the application is acquired, (ii) the new instance of the application is instantiated, and (iii) the new instance is assigned the new license (step 2303). To assign the license to the new instance, the platform can associate an identifier corresponding to the license with an identifier corresponding to the new instance in a data structure. Similarly, to assign the new license to the new instance, the platform can associate an identifier corresponding to the new license with the identifier corresponding to the new instance in the data structure. In the event that the new license is assigned to the new instance, the platform may release the new license when the member concludes her use of the new instance of the application. For example, if the platform receives an input that is indicative of a request from a corresponding member to close the new instance of the application, the platform can cause the new license to be released back to the developer of the application.

Moreover, the platform may allow the new instance—or functionalities permitted by the new instance—to be shared with another member of the tenant. Assume, for example, that the new instance is instantiated in response to receiving an input that is indicative of a request to utilize the application from a first member of the tenant. The first member may be permitted to share the new instance with a second member of the tenant, so long as a concurrent number of members per instance does not exceed a limit set by either the license or the new license. Accordingly, the platform may receive a second input that is indicative of a request, from the first member, to share the new instance of the application with the second member of the tenant. In such a scenario, the platform may create a secondary interface that is viewable and/or manipulable by the second member and then share the secondary interface with the second member, while a primary interface remains viewable and manipulable by the first member. To create the secondary interface, the first member may specify an identifier (e.g., a username or actual name) of the second member through the primary interface. The secondary interface may be one of multiple secondary interfaces that is created for the new instance of the application. Each of the multiple secondary interfaces could be shared with a different member of the tenant.

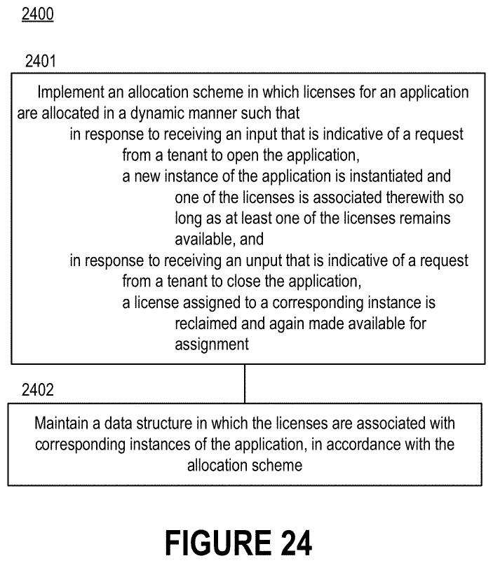

FIG. 24 includes a flow diagram of a process 2400 for dynamically allocating licenses for an application to members of a tenant. As discussed above, the platform may implement an allocation scheme in which the licenses are allocated in a dynamic manner such that in response to receiving an input that is indicative of a request from one of the tenants to open the application, a new instance of the application is instantiated and one of the licenses is associated therewith so long as at least one of the licenses remains available, and in response to receiving input that is indicative of a request to close the application, a license assigned to a corresponding instance is reclaimed and made available to the members of the tenant (step 2401). Moreover, the platform may maintain a data structure in which the licenses are associated with corresponding instances of the application, in accordance with the allocation scheme (step 2402). As part of the allocation scheme, if (a) an input that is indicative of a request from one of the tenants to open the application is received and (b) none of the licenses are available, then (i) a new license for the application is acquired, (ii) a new instance of the application is instantiated, and (iii) the new license is associated with the new instance of the application. Accordingly, the allocation scheme may permit the members to use the application through dynamic instantiation and termination of instances of the application, so long as a current number of instances does not exceed a count of the licenses.

### Processing System

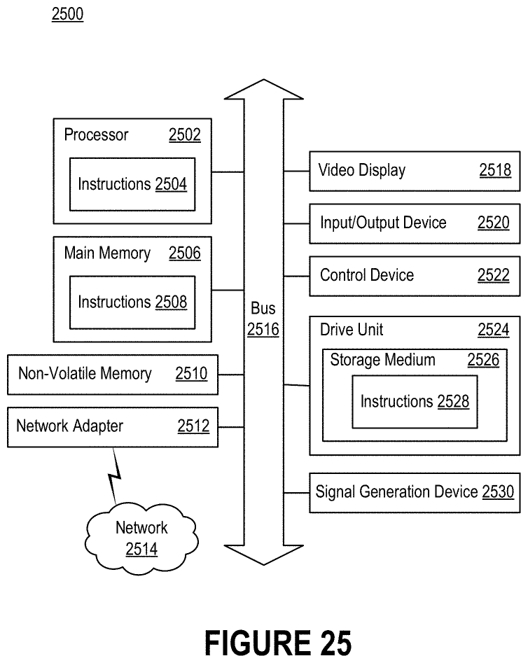

FIG. 25 is a block diagram illustrating an example of a processing system 2500 in which at least some operations described herein can be implemented. For example, components of the processing system 2500 may be hosted on a computing device that includes a platform, or components of the processing system 2500 may be hosted on a computing device that executes a client through which a user is able to interact with the platform.

The processing system 2500 may include a processor 2502, main memory 2506, non-volatile memory 2510, network adapter 2512, video display 2518, input/output device 2520, control device 2522 (e.g., a keyboard or pointing device), drive unit 2524 including a storage medium 2526, and signal generation device 2530 that are communicatively connected to a bus 2516. The bus 2516 is illustrated as an abstraction that represents one or more physical buses or point-to-point connections that are connected by appropriate bridges, adapters, or controllers. The bus 2516, therefore, can include a system bus, a Peripheral Component Interconnect (“PCI”) bus or PCI-Express bus, a HyperTransport or industry standard architecture (“ISA”) bus, a small computer system interface (“SCSI”) bus, a universal serial bus (“USB”), an inter-integrated circuit (“I2C”) bus, or an Institute of Electrical and Electronics Engineers (“IEEE”) standard 1394 bus (also called “Firewire”).

While the main memory 2506, non-volatile memory 2510, and storage medium 2526 are shown to be a single medium, the terms “machine-readable medium” and “storage medium” should be taken to include a single medium or multiple media (e.g., a centralized database, a distributed database, and/or associated caches and servers) that store one or more sets of instructions 2528. The terms “machine-readable medium” and “storage medium” shall also be taken to include any medium that is capable of storing, encoding, or carrying a set of instructions for execution by the processing system 2500.

In general, the routines executed to implement the embodiments of the present disclosure may be implemented as part of an operating system or a specific computer program. Computer programs typically comprise one or more instructions (e.g., instructions 2504, 2508, 2528) set at various times in various memory and storage devices in a computing device. When read and executed by the processor 2502, the instructions cause the processing system 2500 to perform operations to execute elements involving the various aspects of the present disclosure.

Further examples of machine- and computer-readable media include recordable-type media, such as volatile memory devices and non-volatile memory devices 2510, removable disks, hard disk drives, and optical disks (e.g., Compact Disk Read-Only Memory (“CD-ROMS”) and Digital Versatile Disks (“DVDs”)), and transmission-type media, such as digital and analog communication links.

The network adapter 2512 enables the processing system 2500 to mediate data in a network 2514 with an entity that is external to the processing system 2500 through any communication protocol supported by the processing system 2500 and the external entity. The network adapter 2512 can include a network adaptor card, a wireless network interface card, a router, an access point, a wireless router, a switch, a multilayer switch, a protocol converter, a gateway, a bridge, a bridge router, a hub, a digital media receiver, a repeater, or any combination thereof.

### REMARKS

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the relevant art to understand the claimed subject matter, the various embodiments, and the various modifications that are suited to the particular uses contemplated.

Although the Detailed Description describes certain embodiments and the best mode contemplated, the technology can be practiced in many ways no matter how detailed the Detailed Description appears. Embodiments may vary considerably in their implementation details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon.

What is claimed is:

1. A non-transitory medium with instructions stored thereon that, when executed by a processor of a computing device, cause the computer server to perform operations comprising:
receiving an input that is indicative of an instruction from a member of a tenant to open an application,
wherein utilization of the application by members of the tenant is limited to a maximum number of instances,
wherein the maximum number of instances is based on a number of licenses that the tenant has for the application;
confirming, in response to said receiving, that a current number of instances of the application being utilized by the members is less than the maximum number of instances;
in response to said confirming,
causing an instance of the application to be instantiated that is utilizable by the member; and
assigning one of the licenses to the instance by associating a first identifier associated with the instance with a second identifier associated with a license in a data structure.

2. The non-transitory medium of claim 1, wherein the number of the licenses is dynamically variable to account for changes in utilization of the application over time.

3. The non-transitory medium of claim 1, wherein the operations further comprise:
receiving a second input that is indicative of an instruction from the member to close the application; and
in response to said receiving,
revoking the license assigned to the instance, such that the license is again made available for assignment; and
terminating the instance of the application.

4. The non-transitory medium of claim 1, wherein the operations further comprise:
receiving a second input that is indicative of an instruction from a second member of the tenant to open the application;
determining that the current number of instances of the application being utilized by the members is equal to the maximum number of instances;
in response to said determining,
acquiring another license for the application, to be included in the licenses that are available to the members;
causing a second instance of the application to be instantiated that is utilizable by the second member; and
assigning the other license to the second instance by associating a third identifier associated with the second instance with a fourth identifier associated with the other license in the data structure.

5. The non-transitory medium of claim 1, wherein the operations further comprise:
determining that, over an interval of time, utilization of the licenses by the members falls below a threshold; and
in response to said determining,
causing at least one of the licenses to be released back to a developer of the application.

6. The non-transitory medium of claim 5, wherein a number of licenses released back to the developer is based on the utilization of the plurality of licenses over the interval of time.

7. The non-transitory medium of claim 1, wherein said assigning causes the license to be assigned to the instance rather than the member or a computing device that is used by the member to submit the instruction.

8. A method performed by a computer program executing on a computer server, the method comprising:
maintaining a plurality of licenses for an application to be used by members of a tenant;
receiving, over time, inputs that are indicative of requests from the members to utilize the application;
allocating the plurality of licenses in a dynamic manner such that
in response to a determination that a current number of instances of the application is less than a count of the plurality of licenses,
(i) a new instance of the application is instantiated, and
(ii) the new instance is assigned a license from among the plurality of licenses, and
in response to a determination that the current number of instances of the application is equal to the count of the plurality of licenses,
(i) a new license for the application is acquired,
(ii) the new instance of the application is instantiated, and
(iii) the new instance is assigned the new license.

9. The method of claim 8,
wherein to assign the license to the new instance, the computer program associates a first identifier corresponding to the license with a second identifier corresponding to the new instance in a data structure, and
wherein to assign the new license to the new instance, the computer program associates a third identifier corresponding to the new license with the second identifier corresponding to the new instance in the data structure.

10. The method of claim 8, further comprising:
in the event that the new instance is assigned the new license,
receiving an input that is indicative of an instruction from a corresponding member to close the new instance of the application;
terminating the new instance of the application; and
causing the new license to be released back to a developer of the application.

11. The method of claim 8, wherein the requests are addressed sequentially in a member-agnostic manner, such that a single member is able to provoke instantiation of multiple instances of the application on a single computing device.

12. The method of claim 8,
wherein the new instance is instantiated in response to receiving an input that is indicative of a request to utilize the application from a first member of the tenant, and
wherein the first member is permitted to share the new instance with a second member of the tenant, so long as a concurrent number of members per the new instance does not exceed a limit set by either the license or the new license.

13. The method of claim 8,
wherein the new instance is instantiated in response to receiving an input that is indicative of a request to utilize the application from a first member of the tenant, and
wherein the method further comprises:
receiving a second input that is indicative of a request, from the first member, to share the new instance of the application with a second member of the tenant;
creating a secondary interface that is viewable and/or manipulable by the second member; and
sharing the secondary interface with the second member while a primary interface remains viewable and manipulable by the first member.

14. The method of claim 13, wherein the secondary interface is one of multiple secondary interfaces created for the new instance of the application, and wherein each of the multiple secondary interfaces is shared with a different member of the tenant.

15. The method of claim 13, wherein the primary interface is automatically generated by the computer program when the new instance is instantiated.

16. The method of claim 13, wherein the request is provided through the primary interface and includes an identifier that corresponds to the second member.

17. A method for dynamically allocating licenses for an application to members of a tenant, the method comprising:
implementing an allocation scheme in which the licenses are allocated in a dynamic manner such that
in response to receiving an input that is indicative of a request from one of the members to open the application,
a new instance of the application is instantiated and one of the licenses is assigned thereto, so long as at least one of the licenses remains available, and
in response to receiving an input that is indicative of a request from one of the members to close the application,
a license assigned to a corresponding instance is reclaimed and again made available for assignment; and
maintaining a data structure in which the licenses are associated with corresponding instances of the application, in accordance with the allocation scheme.

18. The method of claim 17, wherein as part of the allocation scheme,
if
(a) an input that is indicative of a request from one of the tenants to open the application is received, and
(b) none of the licenses are available,
then
(i) a new license for the application is acquired,
(ii) a new instance of the application is instantiated, and
(iii) the new license is associated with the new instance of the application.

19. The method of claim 17, wherein the allocation scheme permits the members to use the application through dynamic instantiation and termination of instances of the application, so long as a current number of instances does not exceed a count of the licenses.

20. The method of claim 17,
wherein said implementing and said maintaining are performed by a computer program that is executing on a computer server, and
wherein the computer program supports, and the computer server exports, an application programing interface that defines capabilities of the computer program.
